(19) United States
(12) Patent Application Publication
(10) Pub. No.: US 2011/0037403 A1
(43) Pub. Date: Feb. 17, 2011

(54) MODULATED LIGHT SOURCE SYSTEMS AND METHODS.

(75) Inventors: Marc DeVincentis, Palto Alto, CA (US); Marcus Duelli, Seattle, WA (US); Anthony D. McGettigan, Santa Rosa, CA (US); Paul Ralston, Boulder, CA (US)

Correspondence Address: SCHWEGMAN, LUNDBERG & WOESSNER, P.A., P.O. BOX 2938, MINNEAPOLIS, MN, 55402, US

(73) Assignee: LUXIM CORPORATION, SUNNYVALE, CA (US)

(21) Appl. No.: 12/445,659

(22) PCT Filed: Oct. 16, 2007
(86) PCT No.: PCT/US07/22075

§ 371 Date: Nov. 3, 2010

Related U.S. Application Data
(60) Provisional application No. 60/852,290, filed on Oct. 16, 2006.

(51) Int. Cl. H05B 41/24

(52) U.S. Cl. 315/248

(57) ABSTRACT

An electrodeless plasma lamp and method of generating light is described. The lamp may comprise a lamp body comprising a dielectric material having a relative permittivity greater than 2. A lamp drive circuit is coupled to the lamp body and configured to provide radio frequency (RF) power to the lamp body. A bulb is positioned adjacent to the lamp body, the bulb containing a fill that forms a plasma when the RF power is coupled to the fill from the lamp body. The lamp drive circuit includes a control circuit to control the RF power to vary a temperature of the fill to emit light at adjustable output intensities. The control circuit may be configured to modulate a frequency of the RF power. In an example embodiment, the control circuit is configured to modulate the frequency in the range of 10 Hz to 10 KHz.

### RELATED APPLICATIONS

This patent application claims the priority benefit of U.S. Provisional Patent Application Ser. No. 60/852,290 filed Oct. 16, 2006 and entitled “MODULATED LIGHT SOURCE SYSTEMS AND METHODS”, which application is incorporated herein by reference.

### BACKGROUND

1. Field

The field relates to electronic display systems and methods, and more particularly to systems and methods for modulating light sources and for dynamically modulating brightness or enhancing tonal balance in a display system.

2. Background

Micro-display projection systems typically project images which are generated by one or more electronic micro-displays and pass through optical elements, such as matching optics and projection optics, onto a screen. Such systems may mimic full color using sub-pixels for individual color segments, such as red, green and blue (RGB) or cyan, yellow and magenta (CYM) color segments. When a broad-spectrum white light source is used in a micro-display projection system such as a digital light processing (DLP) system, a color wheel often is used to split the light into color components. A broadband light source typically does not emit a flat spectrum, so some form of color tonal balance compensation may be required. In typical projection systems using a non-modulated light source, the luminous flux may be fixed and illuminance compensation may be required to limit the light reaching the color wheel. This may be achieved in some systems with a mechanical aperture stop which may have two significant drawbacks: expense and compromise on reliability due to use of a moving part; and slow response time of the mechanism.

While various techniques have been suggested for improving light transmission efficiency and color tonal balance in systems utilizing a color wheel, there remains a desire for improved systems and methods for providing enhanced screen brightness, color balance and other compensation in the projection of video images.

### BRIEF DESCRIPTION OF THE DRAWINGS

FIG. 1 schematically depicts a micro-display projection system according to an example embodiment utilizing a modulated light source, color wheel, a collection optics assembly, matching optics assembly, micro-display imager, system control electronics, projection optics assembly, and screen.

FIG. 2A is a functional block diagram of a FIG. 1 projection system utilizing a single color wheel, matching optics assembly, and micro-display imager.

FIG. 2B is a functional block diagram of an alternative configuration of a projection system utilizing separate primary-color filter assemblies, and dedicated matching optics assemblies and micro-display imagers.

FIG. 3A is a cross-section and schematic view of an example electrodeless plasma lamp that may be used as a light source in a projection system according to an example embodiment.

FIG. 3B is a perspective cross section view of a lamp body with a cylindrical outer surface according to an example embodiment.

FIGS. 4A, 4B and 4C schematically depict three techniques using variable external attenuation to modulate the gain of a fixed-gain amplifier for a light source according to an example embodiment.

FIGS. 5A and 5B schematically depict two techniques using direct control of a variable-gain component of an amplifier to modulate the amplifier gain for a light source according to an example embodiment.

FIG. 6 schematically depicts a lamp drive circuit with a phase shifter and three stage amplifier with gain control according to an example embodiment.

FIG. 7 schematically shows an implementation of system control electronics for optimizing the dynamic range of a projection system for image frames according to an example embodiment.

FIG. 8 schematically depicts programmable color tonal balancing in a projection system where the light source is modulated to adjust the output intensity of the light source for different color segments of a color wheel according to an example embodiment.

FIG. 9A schematically depicts a color wheel customized to compensate for green-snow in a projection system lacking capability for modulating the light source intensity.

FIG. 9B schematically depicts how green-snow compensation can be performed in a projection system having a modulated light source according to an example embodiment without requiring customization of the green segment of the color wheel.

FIG. 10 schematically depicts the software operations and logic used by the system control electronics to implement compensation for green-snow according to an example embodiment.

### DETAILED DESCRIPTION

While the present invention is open to various modifications and alternative constructions, the embodiments shown in the drawings will be described herein in detail. It is to be understood, however, there is no intention to limit the invention to the particular forms disclosed. On the contrary, it is intended that the invention cover all modifications, equivalences and alternative constructions falling within the spirit and scope of the invention as expressed in the appended claims.

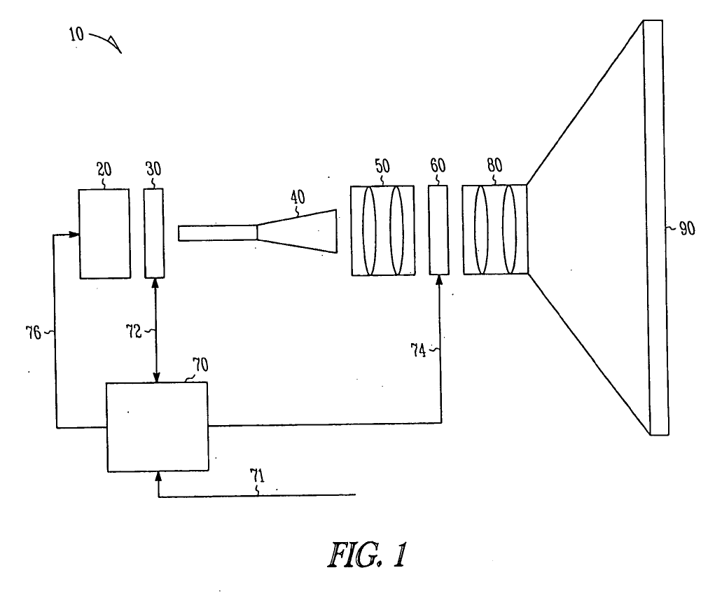

Referring to FIG. 1, an example micro-display projection system 10 includes a modulated light source 20, color wheel 30, collection optics assembly 40, matching optics assembly 50, micro-display imager 60, system control electronics (SCE) 70, projection optics assembly 80, and screen 90. Light source 20 may be an electrodeless plasma lamp that emits broad-spectrum white light to color wheel 30 which may be divided into red-, green- and blue-filter sectors. Other color segments may also be used, such as Cyan, Yellow and Magenta. Some color wheels may also include other color segments, such as a white color segment, and other types of color filters may be used in other embodiments. Typically, color wheel 30 is driven at a preselected rotation rate (e.g., about 120 or 240 rotations per second in some embodiments) by the system control electronics 70; its rotational phase (i.e., angular position) is fed back via two-way link 72. In this example, rapidly alternating primary-color light exiting the color wheel reaches micro-display imager 60 after passing through matching optics assembly 50. In this embodiment, the system control electronics 70 performs the function of translating the frame data encoding the image to be projected into detailed commands for the micro-display imager 60. For each color primary (e.g., R, G or B) a set of pixel elements on the micro-display imager 60 is commanded by the system control electronics 70 via a one-way link 74 to spatially modulate that color, forming a pattern that is the monochromatic primary component of the image being displayed.

In this example embodiment, each pattern consists of a two-dimensional array of sub-pixels for each color, of varying intensity. The micro-display imager 60 may selectively control the light projected to the screen 90 for each sub-pixel. With some micro-display imagers 60, the light may be selectively transmitted through the micro-display imager to the screen 90 (as suggested by the arrangement shown in FIG. 1). Other micro-display imagers 60 may selectively reflect light to the screen 90.

One type of micro-display imager that may be used in example embodiments is a DLP® microdisplay. DLP® microdisplays use a grid of micromirrors to selectively reflect light to the screen 90. These micromirrors form the pixel elements of the microdisplay. In example embodiments, there may be one mirror for each pixel location and each mirror can be tilted very rapidly. Tilting one way allows light to reflect toward the screen, while tilting another way allows the light to be reflected such that the light does not reach the screen. The color shade of each pixel is controlled through a dithering technique that varies the amount of time each pixel reflects light to the screen. In a DLP®-based projection system, intensity typically is controlled using pulse-width modulation (PWM) which achieves proportional modulation of the intensity of any particular pixel by controlling, for each displayed frame, the fraction of time spent in either the “ON” or “OFF” state. That is, modulation of the pixels is quantized, and the “ON/OFF” time ratio of each pixel is varied for each color segment of the color wheel, creating the perception of continuous intensity variation when integrated by an observer's much slower visual response. The ON and OFF states correspond to deflections of micro-mirrors forming the pixels, directing light toward or away from, respectively, the projection optical-axis. The modulation waveform on each pixel is typically limited in duration by two factors. At the short extreme is the response time of the micro-mirror; at the long extreme is the refresh rate of the displayed image. The PWM signal typically is a digitally synthesized pulse spanning a preselected range between these two limits, thereby defining a quantized set of achievable intensity modulation points for a given light brightness impinging on the DLP imager. As the color wheel rotates, the micromirror pixel elements sequentially reflect a set of pixels (one for each color segment) to the screen, with the intensity of each pixel element controlled by PWM. Although they are projected sequentially as the color wheel rotates, the sets of pixels for each color segment appear as a single combined image projected on the screen.

In other types of micro-display imagers that may be used in example embodiments, e.g., liquid crystal display (LCD) spatial-light modulators, the ON and OFF states of the pixel elements correspond, respectively, to states of high and low optical transmission through the imager. In this example embodiment, a single primary-color sub-image is projected onto a screen after passing through appropriate projection optics. In example projection system 10, these are screen 90 and projection optics assembly 80.

Another type of micro-display imager that may be used in example embodiments is liquid crystal on silicon (LCOS). LCOS microdisplays create pixels by covering a reflective silicon chip with crystal material arranged in a grid pattern. Like LCDs, the orientation of the crystals is controlled by applying current to control the amount of light that is reflected from the chip's surface at each pixel location. This controls the ON and OFF states of the pixel elements. The reflected light is then magnified and focused on the inside surface of the screen 90 to form the picture.

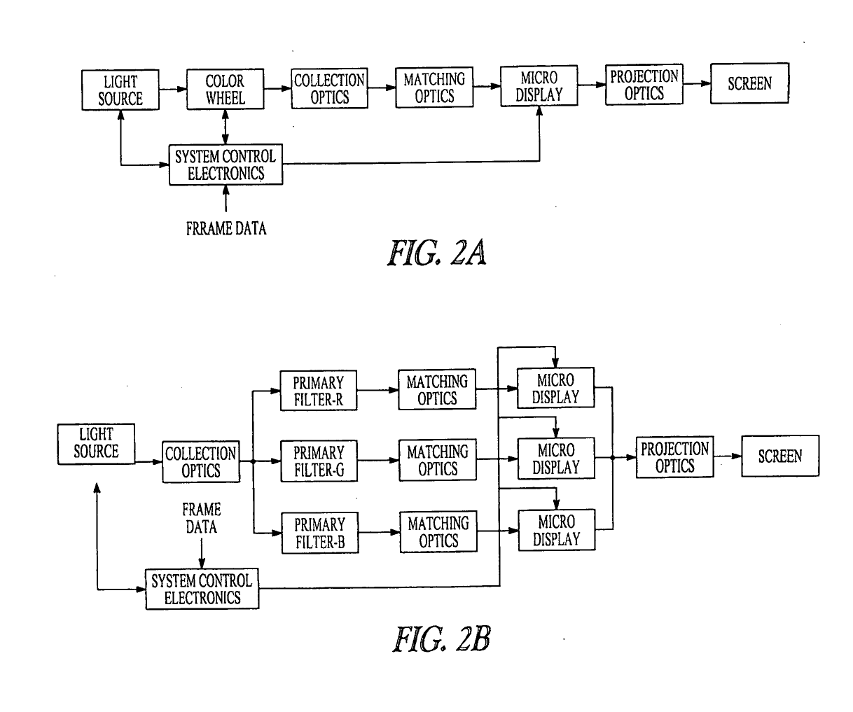

FIG. 2A is a block diagram of the FIG. 1 projection system. In example embodiments of FIG. 1 and FIG. 2A, the light output intensity of the light source 20 is modulated to project a desired video image. In this example, the system control electronics 70 is configured to modulate the power provided to the bulb of the light source and thereby modulate the light output intensity of the light source 20 as described further below. In one example, the light output intensity of the light source 20 is modulated based on the rotation of the color wheel 30 or other color filter. The power to the light source 20 may be increased or decreased for each color segment of the color wheel 30 (or other color filter) to provide a desired color balance. For instance, if the light source has an uneven color spectrum, the light source 20 may be modulated by the system control electronics 70 to compensate for the uneven color spectrum. In another example, the system control electronics 70 may generate signals based on the video images to be projected by the system and modulate the light output intensity of the light source 20 based on the video images to be projected. For instance, the light source 20 may be dimmed for video frames that have a lower level of brightness. This allows a wider range of pulse-width modulation to be used to vary the shades of brightness within the video frame. In another example, the brightness of the green content may be decreased in selected video frames to avoid the appearance of green-snow in dark scenes.

An alternative configuration of a micro-display projection system according to example embodiments may use three primary-color filter assemblies instead of a color wheel, with each color filter assembly optically coupled to a dedicated matching assembly and micro-display. The three optical paths are combined at the projection optics assembly. FIG. 2B is a block diagram of this configuration. The system control electronics may also modulate the light source in these example embodiments to compensate for selected video effects (e.g., increasing the available range of PWM available to distinguish shades in darker scenes or compensating for green-snow effect).

As described above, a micro-display projection system according to example embodiments includes a light source capable of being modulated at a desired frequency to control characteristics of a video image displayed by a projection system. In an example embodiment, the power provided to a plasma in a bulb of an electrodeless plasma lamp may be modulated to modulate the light output intensity. In some examples, the light source may be modulated at a high frequency based on the rotation of a color wheel or based on the video images to be displayed. The frequency of modulation may be higher than the rate of rotation of the color wheel or frame rate of the video images in some embodiments. For example, the light source may be modulated for specific color segments of a color wheel (for example, at a rate greater than 120 or 240 times per second) or other color filter. In other examples, the light source may be modulated for particular video images. In some example embodiments, the lamp may be configured to modulate at a frequency in the range of 10 Hz to 10 KHz or more, or any range subsumed therein. In some embodiments, the light output intensity may also be modulated at a lower frequency to perform functions such as optimizing lamp starting, lamp dimming, and compensating for aging components. In example embodiments, the intensity modulation bandwidth may be wide enough to track square-waveforms with periods in the range from 0 Hz (i.e., steady-state control) to 10 kHz or more, or any range subsumed therein. In some examples, the modulation frequency may be greater than 10 Hz, 30 Hz, 100 Hz or 1 KHz or other frequency as desired.

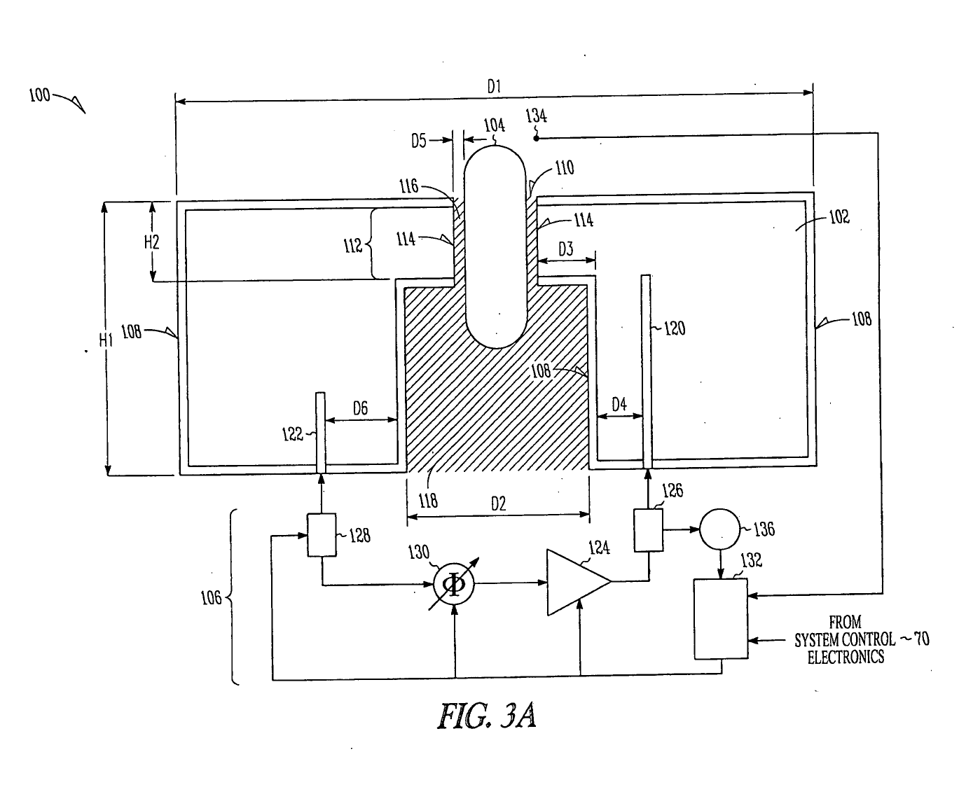

FIG. 3A depicts an electrodeless plasma lamp 100 adapted for use as the light source of projection system 10 in example embodiments. FIG. 3B is a perspective cross section view of a lamp body 102 that may be used in lamp 100. In example embodiments, the plasma lamp may have a lamp body 102 formed from one or more solid dielectric materials and a bulb 104 positioned adjacent to the lamp body. The bulb contains a fill that is capable of forming a light emitting plasma. A lamp drive circuit 106 couples radio frequency power into the lamp body 102 which, in turn, is coupled into the fill in the bulb 104 to form the light emitting plasma. In example embodiments, the lamp body 102 forms a waveguide that contains and guides the radio frequency power. In example embodiments, the radio frequency power may be provided at or near a frequency that resonates within the lamp body 102.

In example embodiments, the outer surfaces of the lamp body 102 may be coated with an electrically conductive coating 108, such as electroplating or a silver paint or other metallic paint which may be fired onto the outer surface of the lamp body. The electrically conductive material 108 may be grounded to form a boundary condition for the radio frequency power applied to the lamp body 102. The electrically conductive coating helps contain the radio frequency power in the lamp body. Regions of the lamp body may remain uncoated to allow power to be transferred to or from the lamp body. For example, the bulb 104 may be positioned adjacent to an uncoated portion of the lamp body to receive radio frequency power from the lamp body, such as the surfaces 114 of the lamp body 102 in the opening 110.

A layer of material 116 may be placed between the bulb 104 and the dielectric material of lamp body 102. In example embodiments, the layer of material 116 may have a lower thermal conductivity than the lamp body 102 and may be used to optimize thermal conductivity between the bulb 104 and the lamp body 102. In some examples, the layer of material comprises alumina powder. In some example embodiments, alumina powder or other material may also be packed into a recess 118 formed below the bulb 104.

Lamp 100 has a drive probe 120 inserted into the lamp body 102 to provide radio frequency power to the lamp body 102. In the example of FIG. 1A, the lamp also has a feedback probe 122 inserted into the lamp body 102 to sample power from the lamp body 102 and provide it as feedback to the lamp drive circuit 106.

A lamp drive circuit 106 including a power supply, such as amplifier 124, may be coupled to the drive probe 120 to provide the radio frequency power. The amplifier 124 may be coupled to the drive probe 120 through a matching network 126 to provide impedance matching. In an example embodiment, the lamp drive circuit 106 is matched to the load (formed by the lamp body, bulb and plasma) for the steady state operating conditions of the lamp. The lamp drive circuit 106 is matched to the load at the drive probe 120 using the matching network 126.

In example embodiments, radio frequency power may be provided at a frequency in the range of between about 0.1 GHz and about 10 GHz or any range subsumed therein. The radio frequency power may be provided to drive probe 120 at or near a resonant frequency for lamp body 102. The frequency may be selected based on the dimensions, shape and relative permittivity of the lamp body 102 to provide resonance in the lamp body 102. In example embodiments, the frequency is selected for a fundamental resonant mode of the lamp body 102, although higher order modes may also be used in some embodiments. In example embodiments, the RF power may be applied at a resonant frequency or in a range of from 0% to 10% above or below the resonant frequency or any range subsumed therein. In some embodiments, RF power may be applied in a range of from 0% to 5% above or below the resonant frequency. In some embodiments, power may be provided at one or more frequencies within the range of about 0 to 50 MHz above or below the resonant frequency or any range subsumed therein. In another example, the power may be provided at one or more frequencies within the resonant bandwidth for at least one resonant mode. The resonant bandwidth is the full frequency width at half maximum of power on either side of the resonant frequency (on a plot of frequency versus power for the resonant cavity).

In example embodiments, the radio frequency power causes a light emitting plasma discharge in the bulb. In example embodiments, power is provided by RF wave coupling. In example embodiments, RF power is coupled at a frequency that forms a standing wave in the lamp body (sometimes referred to as a sustained waveform discharge or microwave discharge when using microwave frequencies). In other embodiments, a capacitively coupled or inductively coupled electrodeless plasma lamp may be used. Other high intensity discharge lamps may be used in other embodiments.

The amplifier 124 may have a gain control that can be used to adjust the gain of the amplifier 124. Amplifier 124 may include either a plurality of gain stages or a single stage. The gain control signal may be generated by control electronics 132 and provided to amplifier 124. Modulating the amplifier gain results in modulation of the temperature of the plasma in the bulb, so that the intensity of light emitted by the plasma is modulated. Control electronics 130 can range from a simple analog feedback circuit to a microprocessor/microcontroller with embedded software or firmware that controls the operation of the lamp drive circuit. The control electronics 130 may include a lookup table or other memory that contains control parameters (e.g., amount of phase shift or amplifier gain) to be used when certain operating conditions are detected. In example embodiments, feedback information regarding the lamp's light output intensity is provided either directly by an optical sensor 134, e.g., a silicon photodiode sensitive in the visible wavelengths, or indirectly by an RF power sensor 136, e.g., a rectifier. The RF power sensor 136 may be used to determine forward power, reflected power or net power at the drive probe 120 to determine the operating status of the lamp. A directional coupler may be used to tap a small portion of the power and feed it to the RF power sensor 136. An RF power sensor may also be coupled to the lamp drive circuit at the feedback probe 122 to detect transmitted power for this purpose. In addition, signals may be provided by system control electronics 70 to the lamp control electronics 132, such as signals generated based on the state of color wheel 30 or based on characteristics of the video frames to be displayed.

In example embodiments, the amplifier 124 may also be operated at different bias conditions during different modes of operation for the lamp. The bias condition of the amplifier 124 has a large impact on DC-RF efficiency. For example, an amplifier biased to operate in Class C mode is more efficient than an amplifier biased to operate in Class B mode, which in turn is more efficient than an amplifier biased to operate in Class A/B mode. However, an amplifier biased to operate in Class A/B mode has a better dynamic range than an amplifier biased to operate in Class B mode, which in turn has better dynamic range than an amplifier biased to operate in Class C mode.

In one example, when the lamp is first turned on, amplifier 124 is biased in a Class A/B mode. Class A/B provides better dynamic range and more gain to allow amplifier 124 to ignite the plasma and to follow the resonant frequency of the lamp as it adjusts during startup. Once the lamp reaches full brightness, amplifier bias is removed which puts amplifier 124 into a Class C mode. This provides improved efficiency. However, the dynamic range in Class C mode may not be sufficient when the brightness of the lamp is modulated below a certain level (e.g., less than 70% of full brightness). When the brightness is lowered below the threshold, the amplifier 124 may be changed back to Class A/B mode. Alternatively, Class B mode may be used in some embodiments. For example, one of these modes may be used when the lamp is dimmed to extend the dynamic range of PWM available for dark scenes (described further below) when the brightness drops below a threshold level. In example embodiments, the threshold may be 50-80% of full brightness or any range subsumed therein.

High frequency simulation software may be used to help select the materials and shape of the lamp body and electrically conductive coating to achieve desired resonant frequencies and field intensity distribution in the lamp body. Simulations may be performed using software tools such as HFSS, available from Ansoft, Inc. of Pittsburgh, Pa., and FEMLAB, available from COMSOL, Inc. of Burlington, Mass. to determine the desired shape of the lamp body, resonant frequencies and field intensity distribution. The desired properties may then be fine-tuned empirically.

While a variety of materials, shapes and frequencies may be used, one example embodiment has a lamp body 102 designed to operate in a fundamental TM resonant mode at a frequency of about 880 MHz (although the resonant frequency changes as lamp operating conditions change). In this example, the lamp has an alumina lamp body 102 with a relative permittivity of 9.2. The lamp body 102 has a cylindrical outer surface as shown in FIG. 3B with a recess 118 formed in the bottom surface. In an alternative embodiment, the lamp body may have a rectangular outer surface. The outer diameter D1 of the lamp body 102 in FIG. 3B is about 40.75 mm and the diameter D2 of the recess 118 is about 8 mm. The lamp body has a height H1 of about 17 mm. A narrow region 112 forms a shelf over the recess 118. The thickness H2 of the narrow region 112 is about 2 mm. As shown in FIG. 3A, in this region of the lamp body 102 the electrically conductive surfaces on the lamp body are only separated by the thin region 112 of the shelf. This results in higher capacitance in this region of the lamp body and higher electric field intensities. This shape has been found to support a lower resonant frequency than a solid cylindrical body having the same overall diameter D1 and height H1 or a solid rectangular body having the same overall width and height. For example, in some embodiments, the relative permittivity is in the range of about 9-15 or any range subsumed therein, the frequency of the RF power is less than about 1 GHz and the volume of the lamp body is in the range of about 10 cm3 to 30 cm3 or any range subsumed therein.

In this example, a hole 110 is formed in the thin region 112. The hole has a diameter of about 5.5 mm and the bulb has an outer diameter of about 5 mm. The shelf formed by the thin region 112 extends radially from the edge of the hole 110 by a distance D3 of about 1.25 mm. Alumina powder is packed between the bulb and the lamp body and forms a layer having a thickness D5 of about ¼ mm. The bulb 104 has an outer length of about 15 mm and an interior length of about 9 mm. The interior diameter at the center is about 2.2 mm and the side walls have a thickness of about 1.4 mm. The bulb protrudes from the front surface of the lamp body by about 4.7 mm.

In this example, the bulb has a high pressure fill of Argon, Kr₈₅, Mercury and Indium Bromide. Argon or other noble gas may be used at pressures above 400 Torr to reduce warm up time for the plasma. The above pressures are measured at 22° C. (room temperature). It is understood that much higher pressures are achieved at operating temperatures after the plasma is formed. For example, the lamp may provide a high intensity discharge at high pressure during operation (e.g., much greater than 2 atmospheres and 10-30 atmospheres or more in example embodiments).

In this example, the drive probe 120 is about 15 mm long with a diameter of about 2 mm. The drive probe 120 is about 7 mm from the central axis of the lamp body and a distance D4 of about 3 mm from the electrically conductive material 108 on the inside surface of recess 118. The relatively short distance from the drive probe 120 to the bulb 104 enhances coupling of power. The feedback probe 122 is a distance D6 of about 11 mm from the electrically conductive material 108. In one example, a 15 mm hole is drilled for the feedback probe 122 to allow the length and coupling to be adjusted. The unused portion of the hole may be filled with PTFE (Teflon) or another material. In this example, the feedback probe 122 has a length of about 3 mm and a diameter of about 2 mm. In another embodiment where the length of the hole matches the length of the feedback probe 122, the length of the feedback probe 122 is about 1.5 mm.

The above dimensions, shape, materials and operating parameters are examples only and other embodiments may use different dimensions, shape, materials and operating parameters.

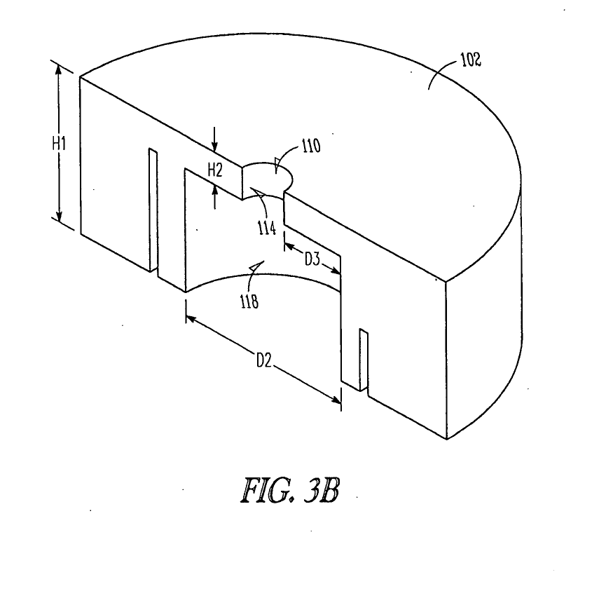

FIGS. 4A, 4B and 4C schematically depict three techniques which use variable external attenuation to modify the gain of an amplifier in an amplifier block such as amplifier 124 when the amplifier is fixed-gain. In FIG. 4A, gain modulation is provided by a variable attenuator 432A connected to preamplifier stage 434A of a two-stage amplifier 430A consisting of stage 434A and a power amplifier stage 436A. In FIG. 4B, variable attenuator 432B is connected between preamplifier stage 434B and power amplifier stage 436B of two-stage amplifier 430B. In FIG. 4C, variable attenuator 432C is connected to power amplifier 436C of single-stage amplifier 430C. In FIGS. 4A, 4B, 4C, modulation control of variable attenuator 432A, 432B, 432C, respectively, is provided by a signal 438A, 438B, and 438C, respectively. These signals may be provided by lamp control electronics 132 and may be based on signals provided by system control electronics 70 to the lamp control electronics 132, such as signals generated based on the state of color wheel 30 or based on characteristics of the video frames to be displayed. At RF and microwave frequencies the most common implementation of electronically variable attenuation is a PIN diode whose impedance is a repeatable function of the bias voltage applied. Typical switching speeds for GaAs PIN-based variable attenuators are less than one microsecond.

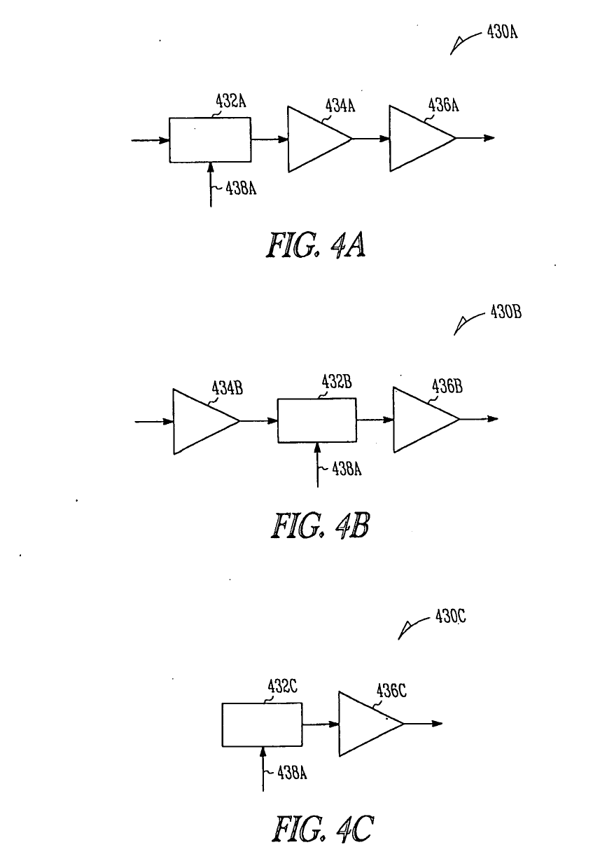

FIGS. 5A and 5B schematically depict two techniques utilizing a variable gain amplifier (VGA). In FIG. 5A, preamplifier stage 544 is a VGA in a two-stage amplifier 524A consisting of stage 544 and power amplifier stage 546. In FIG. 5B, single-stage amplifier 524B is a VGA power amplifier. In FIGS. 5A and 5B, modulation control of preamplifier 544 and power amplifier 524B, respectively, is provided by a signal 548A, 548B, respectively. These signals may be provided by lamp control electronics 132 and may be based on signals provided by system control electronics 70 to the lamp control electronics 132, such as signals generated based on the state of color wheel 30 or based on characteristics of the video frames to be displayed.

The above attenuator techniques can be used to rapidly modulate the lamp output intensity for increasing dynamic range, color balancing and compensating for green-snow effects as described further below.

The power to the plasma in electrodeless lamp 100 may also be modulated using phase shifter 130 in the feedback loop formed by the lamp drive circuit 106 between the feedback probe 122 and drive probe 120. Feedback is provided by feedback probe 122 to the phase shifter 130 through an attenuator 128. The feedback loop automatically oscillates at a frequency based on the load conditions and phase of the feedback signal. This feedback loop may be used to maintain a resonant condition in the lamp body 102 even though the load conditions change as the plasma is ignited and the temperature of the lamp changes. If the phase is such that constructive interference occurs for waves of a particular frequency circulating through the loop, and if the total response of the loop (including the amplifier, lamp, and all connecting elements) at that frequency is such that the wave is amplified rather than attenuated after traversing the loop, the loop will oscillate at that frequency. Whether a particular setting of the phase-shifter 130 induces constructive or destructive feedback depends on frequency. The phase-shifter 130 can be used to finely tune the frequency of oscillation within the range supported by the lamp's frequency response. In doing so, it also effectively tunes how well RF power is coupled into the lamp because power absorption is frequency-dependent.

Thus, the phase-shifter 130 provides fast, finely-tunable control of the lamp output intensity. Both tuning and detuning are useful. For example: tuning can be used to maximize intensity as component aging changes the overall loop phase; detuning can be used to control lamp dimming. In some example embodiments, the phase selected for steady state operation may be slightly out of resonance, so maximum brightness is not achieved. This may be used to leave room for the brightness to be increased and/or decreased by control electronics 132. This can be used for brightness lock to maintain a constant brightness even if components age. This can also be used for brightness adjustment. If the lamp is not operating at resonance for peak brightness, the phase may be shifted to increase brightness. The phase may also be shifted to dim the lamp. In some embodiments, the lamp may be adjusted to 20% to 100% of peak brightness, or any range subsumed therein, while maintaining continuous supply of power to the lamp and without extinguishing the plasma discharge. In some embodiments, this may be accomplished by changing the phase shift without changing the voltage level that controls the gain of the amplifier. In other embodiments, the gain of the amplifier may also be adjusted. The phase shifter 130 can also be used to rapidly modulate the lamp output intensity for increasing dynamic range, color balancing and compensating for green-snow effects as described further below. The wide range of available brightness adjustment (e.g., 20%-100% of peak brightness or any range subsumed therein) allows for significant changes in brightness to be used to compensate for these effects in projection display systems.

In example embodiments, the phase shifter 130 can also be modulated to spread the power provided by the lamp circuit 106 over a larger bandwidth. This can reduce ElectroMagnetic Interference (EMI) at any one frequency and thereby help with compliance with FCC regulations regarding EMI. In example embodiments, the degree of spectral spreading may be from 5-30% or any range subsumed therein. In one example, the control electronics 132 may include circuitry to generate a sawtooth voltage signal and sum it with the control voltage signal to be applied to the phase shifter 130. In another example, the control electronics 132 may include a microcontroller that generates a Pulse Width Modulated (PWM) signal that is passed through an external low-pass filter to generate a modulated control voltage signal to be applied to the phase shifter 130. In example embodiments, the modulation of the phase shifter 130 can be provided at a level that is effective in reducing EMI without any significant impact on the plasma in the bulb.

An example phase shifter 130 is the PS088-315 voltage-controlled phase-shifter available commercially from Skyworks Solutions Inc. of Woburn, Mass. A control voltage signal for the phase shifter 130 may be generated by the control electronics 132 and applied to the phase shifter 130 to control the amount of phase shift. These signals may be based on signals provided by system control electronics 70 to the lamp control electronics 132, such as signals generated based on the state of color wheel 30 or based on characteristics of the video frames to be displayed. The control electronics 132 may also include a lookup table in memory containing parameters indicating the appropriate control voltage signal for various modes of operation. These values may also be interpolated or calculated by the control electronics 132 in some embodiments.

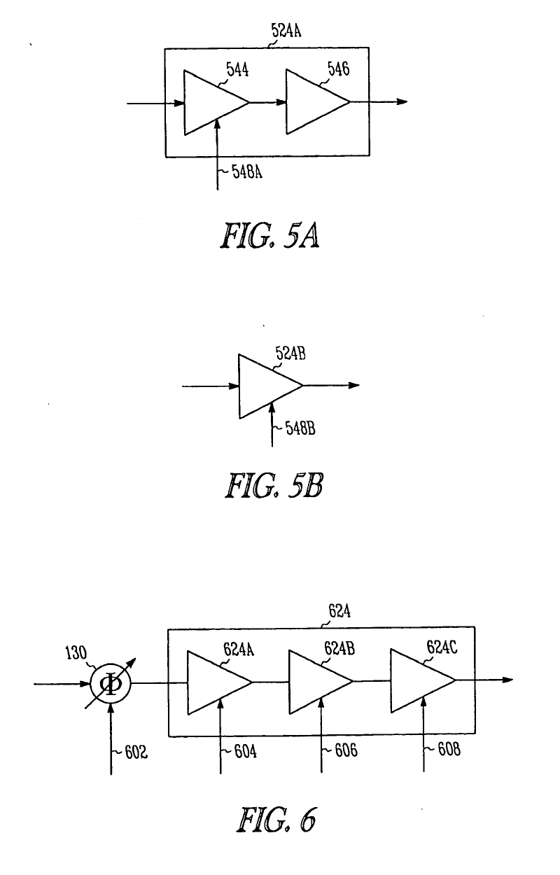

FIG. 6 depicts an example phase shifter 130 and amplifier 624 that may be used in a lamp drive circuit to modulate the lamp output intensity. In this example, the amplifier 624 has three stages, a pre-driver stage 624a, a driver stage 624b and an output stage 624c, and the control electronics 132 provides a separate signal to each stage (drain voltage signal 604 for the pre-driver stage 624a, gate bias voltage signal 606 for the driver stage 624b and gate bias voltage signal 608 for the output stage 624c). The drain voltage of the pre-driver stage can be adjusted to adjust the gain of the amplifier. The gate bias of the driver stage can be used to turn on or turn off the amplifier. The gate bias of the output stage can be used to choose the operating mode of the amplifier (e.g., Class A/B, Class B or Class C). Control electronics 132 also provides a control voltage signal 602 to phase shifter 130 to control the amount of phase shift in the feedback loop. In this example, the control electronics 132 may adjust both the gain of the amplifier through the drain voltage signal 604 for the pre-driver stage 624a and the amount of phase shift through control voltage signal 602 to modulate the output intensity of the lamp. These signals may be based on signals provided by system control electronics 70 to the lamp control electronics 132, such as signals generated based on the state of color wheel 30 or based on characteristics of the video frames to be displayed.

Referring to FIG. 1, using a light source such as plasma lamp 100, the system control electronics 70, depending on the tracking data it receives from color wheel 30 and the commands it issues to micro-display imager 60, provides a command signal to the lamp, via a one-way link 76, to modulate its light output intensity. In example embodiments, the system control electronics performs three major functions: (a) driving and tracking a color wheel; (b) translating the video image to be projected into detailed commands for a micro-display imager; and (c) modulating the intensity of light emitted by the plasma lamp. However, the control electronics may be used in other embodiments to perform a subset of these functions and/or to perform additional control functions for the display system.

In some embodiments, rapidly modulating the light output intensity allows the full dynamic range intrinsic to PWM to be preserved on a frame-by-frame basis. An example serves to illustrate the point. Consider a conventional DLP-based projection system having a broadband light source and associated optics placing L lumens of light onto a color wheel divided into N spectral regions of equal size. For example, N=3 for the simplest case of R, G, B primaries. Let M be the PWM resolution (e.g., M=1024 for 10-bit resolution). The maximum brightness a pixel can project is L/N, corresponding to 100% ON-time; and the minimum brightness is L/MN, corresponding to a single bit of ON-time, assuming the transient time of the mirror motion is negligible. For a bright scene where the maximum brightness is L/N, the full dynamic range of the projection system is utilized. For a dark scene where the maximum brightness is, say, 10· (L/MN), only ten shades of brightness below this can be rendered at each pixel, unacceptably underutilizing the dynamic range of the system.

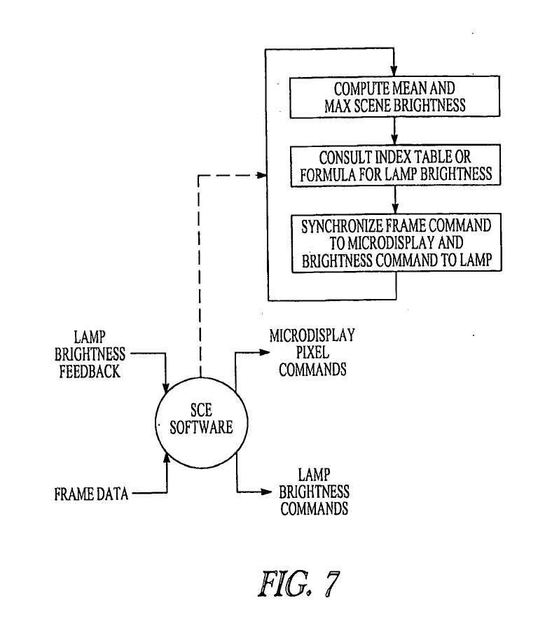

In example embodiments, the dynamic range may be optimized by modulating the light source. In a projection system 10 having a light source such as lamp 100 or 150, the simplest implementation executed by the system control electronics 70 for each image frame is depicted in FIG. 7. In this example, lamp brightness feedback information and frame data are input to software operating according to the following algorithm: (a) compute the mean and/or maximum scene brightnesses to be displayed; (b) consult a pre-computed lamp brightness schedule indexed by (a), and set the light output intensity of the lamp according to the pre-computed lamp brightness from the schedule; (c) for each frame, repeat (a) and (b). In one example, the mean brightness may be calculated by adding the values assigned to each pixel for each color component (e.g., red, green and blue sub-pixels) to determine a brightness for each pixel and then calculating the mean across all pixels for the video image. Other approaches may be used in other embodiments, including providing a higher or lower weighting for sub-pixels of a particular color. Synchronized to each frame, the software generates micro-display pixel and lamp brightness commands. No moving parts are involved, and the modulation speed required of the plasma lamp, viz., faster than the frame rate, is modest. It will be appreciated by those skilled in design of projection systems that variants of this algorithm are also feasible.

In other embodiments, different brightness characteristics of a video image may be used to trigger modulation of the light source. The control electronics may determine whether a video frame or video image (or series of frames or images) has a characteristic for which modulation of the light source is desired. In example embodiments, the light source may be an electrodeless plasma lamp (such as lamp 100) with a power source for coupling power to a bulb. When the characteristic is detected, the power provided to the bulb may be modulated to modulate the light output intensity of the light source. The amount of modulation may be determined based on the particular characteristic that is detected (e.g., mean brightness, maximum brightness, or other characteristics or combinations of characteristics). The modulation may be calculated based on the detected value or may be predetermined and stored in a lookup table. The brightness of the video image projected by the system may be controlled by a combination of adjusting the light output intensity of the light source and controlling the period of time during which the light is projected from the pixel elements of the micro-display imager for the video image (e.g., by pulse width modulation). By adjusting the light output intensity, the range of PWM values available for projecting the video image may be increased over the range that could have been used if the light output intensity had not been adjusted. As a result, the number of shades that may be distinguished within the video image may be increased. This mode is referred to as Dynamic Dark.

For instance, with 10 bits of PWM there are 1024 values that can be selected for each pixel element at maximum brightness. For a dark scene without modulation of the light source, only a subset of these values could be used. If the light output intensity is reduced, the maximum brightness is reduced and a larger number of the PWM values may be used for projecting the video image without exceeding the maximum brightness for the video image. Other embodiments may use a different number of bits and values for PWM, for example between 8 and 16 bits (or any range subsumed therein) providing between 512 and 65536 different PWM values (or any range subsumed therein). In some embodiments, the light output intensity may be adjusted even if some pixels are at a high brightness. While this may prevent some pixels from being displayed at the specified brightness, this may be acceptable where most of the video image is at a lower brightness. The increase in available dynamic range for the majority of the video image may justify attenuating the brightness for a small amount of pixels. The algorithm or lookup table for determining whether to modulate the light output intensity may take these factors into account. For example, the mean brightness of a video image may be used to determine whether to reduce the light output intensity of the light source, but the amount by which it is reduced may also depend upon the number of pixels whose brightness would be attenuated.

In some example embodiments, the light output intensity may be substantially reduced for some dark scenes to increase the dynamic range. In some examples, the brightness may be adjusted to a level within 50%-80% of peak brightness or less. In some examples, the gate bias of the amplifier is selected to enhance efficiency when the lamp operates near full brightness (e.g., in a Class C mode). However, when the brightness drops below a threshold, the bias may be adjusted (e.g., to a Class A/B mode). In some examples, the threshold is within the range of 50%-80% of peak brightness. In a particular example, the threshold is 70% of peak brightness. When brightness will be reduced below the threshold for a frame of video using Dynamic Dark, the gate bias voltage is adjusted for that frame.

In example embodiments, modulation of the light source may also be used for color balance. To compensate for the spectrum emitted by a broadband light source so as to achieve tonal balance, a conventional projection system may use a color wheel with sectors of unequal area tailored according to spectral region. Again, an example serves to illustrate. Suppose the rotation period of a color wheel is 10 milliseconds (ms), and the wheel has three R, G, B 120° sectors. If the spectrum is perfectly flat, the wheel would be designed so that each sector is illuminated for one-third of each period (i.e., 3.3 ms). If the source is brightest in red and lacking in blue, the sectors could be configured so that more “dwell” time is spent illuminating the B-sector than the R-sector. For example the R, G, B dwell times could be 2.5 ms, 3.5 ms and 4.0 ms, respectively. A PWM drive circuit would need to keep track of the wheel phase to determine which sector was being illuminated, and schedule its control accordingly. For example, a “50% brightness” command to a pixel would translate, respectively, to R, G and B ON-times of 1.25 ms, 1.75 ms and 2.0 ms, respectively. A significant drawback of this technique is that the compensation is fixed at the time of manufacture. If the spectrum drifts with age or is subject to manufacturing variation, the compensation will be degraded.

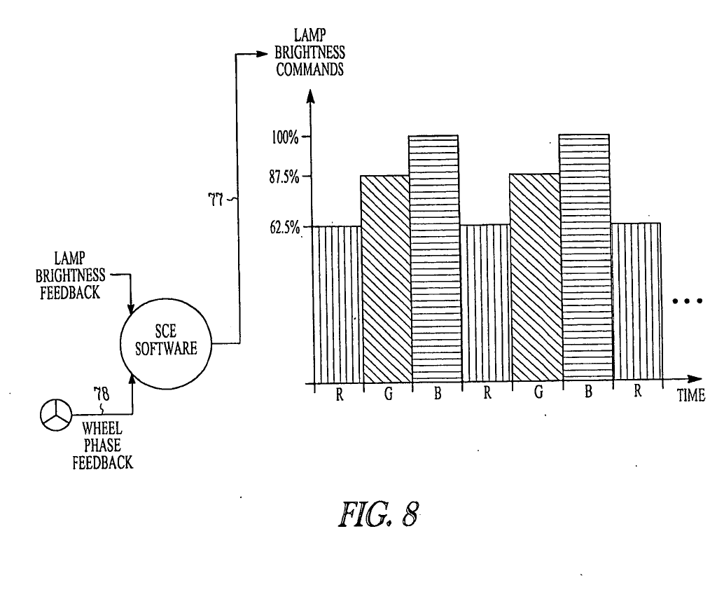

In example embodiments, as depicted schematically in FIG. 8, SCE software modulates the plasma lamp's light output intensity “on-the-fly” via a modulation signal 77 as the phase of the color wheel changes, as informed by a wheel phase feedback signal 78 input to the system control electronics. The modulation frequency is significantly faster than the wheel's rotational frequency (which may be, for example, about 120 or 240 rotations per second), and the lamp's light output intensity is dynamically adjusted according to the wheel sector illuminated. FIG. 8 shows how the intensity might vary for a color wheel with three R, G, B 120° sectors and a dwell time per sector of 3.3 ms. according to an example embodiment. As shown in FIG. 8, significant reductions in brightness may be used for some color segments (e.g., less than 70% of peak brightness for the red segment in FIG. 8). The advantages of such an implementation are significant. Compensation is electronic and programmable, making it possible to calibrate, at the time of manufacture and/or automatically in-service over the lifetime of a projection system, the tonal balance of both a particular light source and the overall system. Moreover, a common color wheel design with standardized sector spectral regions and area distributions can be used for a number of projection system models, saving cost.

In example embodiments, an electrodeless plasma lamp, such as lamp 100, may be used as the light source and may provide a broad spectrum of light. However, the spectrum may be uneven across different colors. The light source may sequentially illuminating a plurality of color segments (such as red, green, blue or cyan, yellow, magenta or other color segments) of a color filter (such as a rotating color wheel). The light may then be projected onto a micro-display imager. The power provided to the bulb of the light source may be modulated to modulate the light output intensity of the light source for one or more of the color segments to compensate for the uneven color spectrum of the light source. For instance, if the spectrum of the light source has a lower level of blue than red, the light output intensity may be adjusted to be higher when it is being used to illuminate the blue color segment than when it is being used to illuminate the red color segment. A similar technique may be used if cyan, yellow and magenta color segments are used. These colors are subtractive primaries—cyan is blue and green without red; yellow is red and green without blue; and magenta is red and blue without green. If the light source has a higher level of red than blue or green, then the light output intensity may be adjusted to be higher when it is being used to illuminate the cyan color segment.

In one example, an Argon, Mercury and Indium Bromide fill is used in the bulb of an electrodeless plasma lamp of the type shown in FIG. 3A. In this example, the color spectrum of the light source has a high level of green relative to blue and red. In an example where a red, blue and green color wheel is used, the light output intensity may be adjusted to be lower when it is being used to illuminate the green color segment. In an example where a cyan, yellow and magenta color wheel is used, the light output intensity may be adjusted to be higher when it is being used to illuminate the magenta color segment.

This approach can also be used to maintain color balance over the lifetime of the lamp. As described above, feedback information regarding the lamp's light output intensity may be obtained from a sensor or other device. This information may be used to detect a change in the spectrum of the light source. If the spectrum changes, the light output intensity may be modulated for one or more of the color segments to compensate for the change.

In modern high definition rear projection televisions, modulation of the lamp output intensity for color balancing using a color wheel may require very rapid modulation of the light source. For example, the frame period of 1/60^{th} of a second and the color wheel may rotate at 14400 rotations per minute (240 rotations per second), completing four revolutions during each frame. With three color segments of equal size, the light output intensity may need to be modulated at a frequency of about 720 Hz (if modulation is required for each color segment). With six color segments (e.g., RGBRGB or RGBCYM), the frequency of modulation increases to 1440 Hz. Accordingly, example embodiments may use an attenuator and/or phase shifter with fast switching time (in one example, less than one microsecond) for fast modulation of an electrodeless plasma lamp.

In example embodiments, modulation of the light source may also be used to compensate for green-snow effects. In a conventional PWM system with digitally synthesized pulses, the minimum brightness level command at each pixel typically corresponds to the minimum (“lowest-significant-bit” (LSB)) pulse-width. A “black” pixel is formed by projecting the LSB-level brightness equally in the three primary color sub-pixels forming the pixel. Because human visual response is most sensitive in the green, peaking at a wavelength of 550 nanometers (nm), a black pixel will be perceived as green; hence the term “green-snow.” In a frame with largely dark content, a projection system with on-the-fly dynamic range optimization can, by reducing the brightness illuminating the color wheel, make the LSB-level brightness very low. However, in a frame with significant contrast, i.e., where there is a large difference between maximum and minimum brightness areas), an optimized dynamic range requires a brighter LSB-level. The PWM resolution determines the width of the dynamic range, while compensation optimizes the match between a particular dynamic range and the light output.

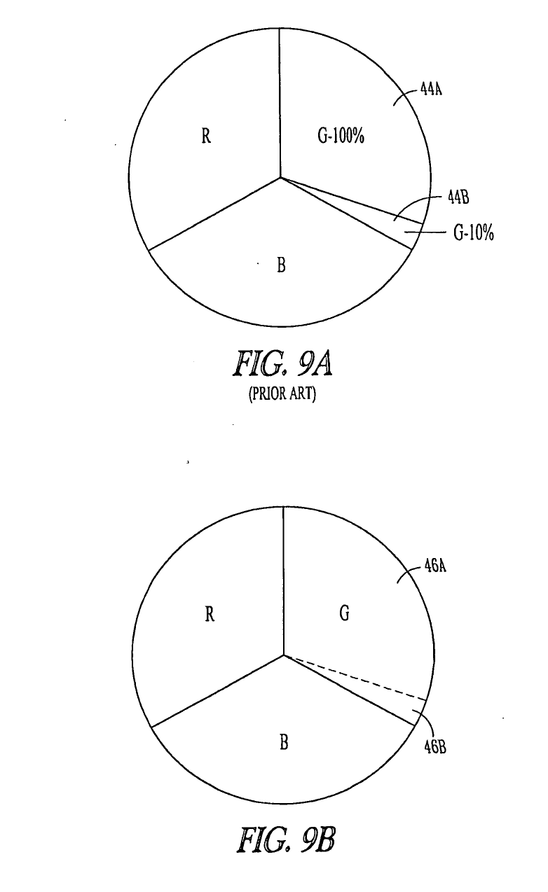

In a projection system whose light source intensity cannot be modulated, compensation for the green-snow effect may be achieved by using a color wheel whose sector areas are tailored to match the source emission spectrum. FIG. 9A schematically depicts a color wheel whose green region has been divided into areas 44A coated for maximum transmission (“G-100%”) and areas 44B with significant attenuation (“G-10%”). As the PWM-type system control electronics tracks the wheel phase, it times a green LSB sub-pixel to be ON when an area 44B is illuminated, thereby reducing the sub-pixel's green content. That is, the green sub-pixel is dimmer compared to the adjacent red and blue sub-pixels. This technique reduces maximum optical throughput in the green.

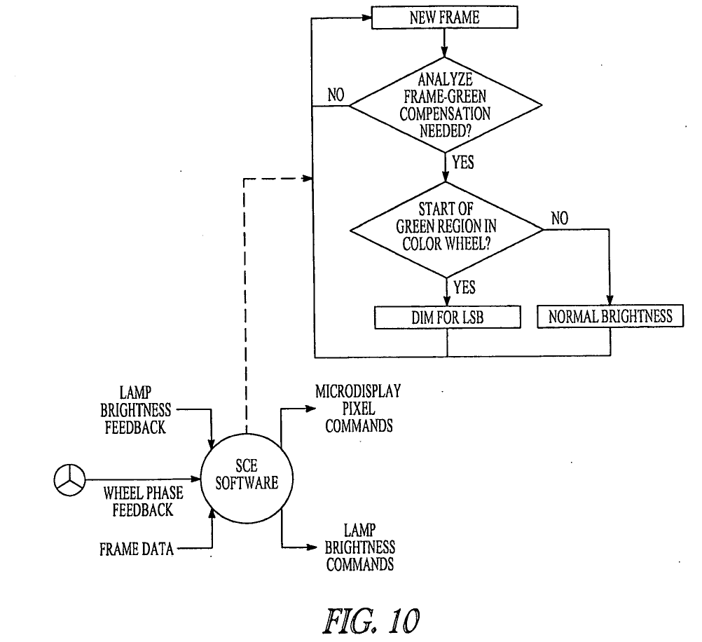

In a projection system with an intensity-modulated light source, such as electrodeless plasma lamp 100, compensation can be achieved without a tailored color wheel. Instead, as depicted in FIG. 9B, the PWM system control electronics coordinates the lamp's light output intensity to be dimmed over a period corresponding to the LSB green pulse, when an area 46B of a sector 46A of the color wheel is illuminated. The modulation bandwidth of the source must be fast compared to the PWM LSB pulse-width. Although this compensation scheme diminishes total light throughput, its implementation is totally electronic so a generic color wheel, common to a number of projection system models, can be used. An additional advantage is that compensation can be modified on a frame-by-frame basis, permitting implementation in software of heurisitic rules optimizing the trade-off between optical throughput/image brightness and green-snow compensation. There are numerous feasible optimization schemes. One simple scheme is to omit green-snow compensation for any frame where the amount and spatial distribution of green content exceed predetermined levels such that the green-snow artifact would be imperceptible. FIG. 10 schematically shows the inputs to and outputs from the SCE software, and the logic used to implement this scheme. As shown in FIG. 10, SCE software analyzes each frame to determine whether green compensation is needed. In an example embodiment, the video image characteristics used to trigger compensation (such as amount and spatial distribution of green content and darkness of the video image) may be determined empirically and stored in a lookup table or indexed schedule. Alternatively, one or more of these characteristics may be calculated for the video image and compared against a threshold for determining whether to perform green compensation. If green compensation is triggered, the light source is dimmed for the LSB of the green color segment. It will be appreciated that the light output intensity could also be dimmed in other portions of the green segment (beyond the LSB), although the LSB is typically used because the green-snow effect generally appears in dark scenes. However, this approach allows for optimization schemes that adjust the light output intensity during other portions of the green segment (or any other color segment).

Modulation of the light source may also be used for other color and/or brightness adjustments to video images to be displayed. Video images may be analyzed to detect characteristics for which adjustment is desired. The characteristics triggering adjustments may be stored in a lookup table or indexed schedule, along with the corresponding modulation of the light source that is desired. When a characteristic is detected, the light source may be modulated in accordance with the corresponding entry in the lookup table or indexed schedule. The timing and duration of the modulation may also be specified, such as modulation for one or more frames of video or for one or more color segments of a color wheel.

For each of the above methods, a light source is used that can be modulated at the desired frequency. For example, an electrodeless plasma lamp, such as lamp 100 or other electrodeless plasma lamp may be used. Other modulated light sources may be used in other embodiments.

1-66. (canceled)

67. An electrodeless plasma lamp comprising:
a lamp body comprising a dielectric material having a relative permittivity greater than 2;
a lamp drive circuit coupled to the lamp body and configured to provide radio frequency (RF) power to the lamp body; and
a bulb adjacent to the lamp body, the bulb containing a fill that forms a plasma when the RF power is coupled to the fill from the lamp body,
the lamp drive circuit including a control circuit to control the RF power to vary a temperature of the fill to emit light at adjustable output intensities.

68. The electrodeless plasma lamp of claim 67, wherein the control circuit is configured to modulate a frequency of the RF power.

69. The electrodeless plasma lamp of claim 68, wherein control circuit is configured to modulate the frequency in the range of 10 Hz to 10 KHz.

70. The electrodeless plasma lamp of claim 68, wherein the RF power source is configured to provide power to the lamp body at about a resonant frequency for the lamp body, the control circuit being configured to modulate the frequency about the resonant frequency.

71. The electrodeless plasma lamp of claim 70, wherein the resonant frequency is at a fundamental resonant mode of the lamp body.

72. The electrodeless plasma lamp of claim 70, wherein the control circuit controls the lamp drive circuit to provide the RF power in a range of about 0% to 10% above or below the resonant frequency.

73. The electrodeless plasma lamp of claim 70, wherein the control circuit controls the lamp drive circuit to provide the RF power in a range of about 0% to 5% above or below the resonant frequency.

74. The electrodeless plasma lamp of claim 67, wherein the control circuit comprises:
memory to store instructions; and
a processor coupled to the memory to execute the instructions thereby to control operation of the lamp drive circuit.

75. The electrodeless plasma lamp of claim 74, wherein the control circuit consults a pre-computed brightness schedule and sets a light output intensity of the lamp according to a pre-computed lamp brightness from the schedule.

76. The electrodeless plasma lamp of claim 74, wherein the memory stores lamp control parameters.

77. The electrodeless plasma lamp of claim 74, wherein the control circuit is configured to modulate a frequency of the RF power, the modulation being predetermined and stored in a look-up table.

78. The electrodeless plasma lamp of claim 67, further comprising:
an amplifier to generate the RF power; and
a variable attenuator coupled to the amplifier, the control circuit providing control signals to the variable attenuator thereby to control the temperature of the plasma.

79. The electrodeless plasma lamp of claim 67, further comprising:
a variable gain amplifier to generate the RF power, the control circuit providing control signals to the variable gain amplifier thereby to control the temperature of the plasma.

80. The electrodeless plasma lamp of claim 67, further comprising a sensor coupled to the control circuit to obtain a signal regarding the light output intensity of the lamp, wherein the control circuit utilizes the signal from the sensor to control modulation of the RF power provided to the lamp body.

81. The electrodeless plasma lamp of claim 67, wherein the control circuit is configured to modulate the RF power coupled to the bulb corresponding to respective color segments of a color wheel to provide a desired color balance.

82. The electrodeless plasma lamp of claim 67, further comprising an electrically conductive coating on the surface of the lamp body.

83. The electrodeless plasma lamp of claim 67, wherein the control circuit is configured to modulate the power provided to the bulb at a frequency greater than about 30 Hz.

84. The electrodeless plasma lamp of claim 67, wherein the control circuit is configured to modulate the power provided to the bulb at a frequency greater than about 100 Hz.

85. The electrodeless plasma lamp of claim 67, wherein the control circuit is configured to modulate the power provided to the bulb at a frequency greater than about 1 kHz.

86. An electrodeless plasma lamp comprising:
a lamp body comprising a dielectric material having a relative permittivity greater than 2;
a lamp drive circuit coupled to the lamp body and configured to provide radio frequency (RF) power to the lamp body; and
a bulb adjacent to the lamp body, the bulb containing a fill that forms a plasma when the RF power is coupled to the fill from the lamp body,
means for controlling the RF power to vary a temperature of the fill to emit light at different adjustable output intensities.

87. A method of controlling a temperature of a light emitting plasma, the method comprising:
providing a lamp body comprising a dielectric material having a relative permittivity greater than 2 and bulb adjacent to the lamp body, the bulb containing a fill;
coupling radio frequency (RF) power from a lamp drive circuit to the fill to form a light emitting plasma; and
controlling the RF power coupled to the lamp body to vary a temperature of the fill to emit light at different adjustable output intensities.
